(19) United States
(12) Patent Application Publication
(10) Pub. No.: US 2003/0105729 A1
(43) Pub. Date: Jun. 5, 2003

(54) Method and system for remotely accessing mailbox to verify contents using tagged mails

(75) Inventor: Aaron Waxler, Floral Park, NY (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/015,839

(22) Filed: Nov. 30, 2001

(51) Int. Cl. G06F 17/00

(52) U.S. Cl. 705/404; 705/410

(57) ABSTRACT

The invention includes a system for, a method for, and a method of doing business by remotely determining the contents of a mail receptacle. Mail includes a machine-readable label incorporated into a piece of mail programmed with at least one property of the piece of mail. A mail receptacle includes a machine-readable label reader for reading the machine-readable label, a processor for receiving the at least one property of the piece of mail from the machine-readable label reader, and a memory for storing the at least one property of the piece of mail. The memory can be remotely accessed by a means for remotely accessing the memory to determine the contents of the mail receptacle.

### FIELD OF THE INVENTION

The invention relates to conventional postal systems, such as the United States Postal Service. The invention also relates to systems that employ machine-readable labels to store data and deliver them to readers when scanned.

### BACKGROUND OF THE INVENTION

Conventional postal systems, such as the United States Postal Service, courier mails throughout the world. Mail is sent from one destination and delivered to another. A mail recipient must then take delivery of their mail. This delivery can occur directly by a delivery person directly passing mail to its intended recipient. However, it is more often the case that delivery includes an intermediate receptacle for mail such as a mailbox, mail slot, package room, post office box, etc.

Currently a recipient has no way of checking their mail receptacle remotely. Rather, they must either check it personally, or provide an agent to check for them. The agent can then call the recipient and inform them of the contents of their mail receptacle. This is inconvenient for people who travel or await an important piece of mail.

Modern technology has allowed remote access to many electronic and telephony sources of information. Examples of these alternate methods of information delivery include email, voicemail, and electronic faxing. The advantage these information delivery systems is that they can be accessed remotely. For example, a recipient can remotely verify the contents of their email by logging onto an email server from any available computer with Internet access and checking what information has arrived in their virtual email box. These alternate information delivery systems provide added convenience and accessibility over conventional postal systems. However, conventional postal systems are required for items that require physical delivery such as goods, written correspondence, currency, promissory notes, and periodicals.

Currently, a piece of mail in a conventional postal system is adorned with proof of postage payment (i.e., a stamp) and likely some information of its origin (i.e., a return address or logo). A piece of mail may also be adorned with a barcode which, when read by a barcode-reader, can contain limited amounts of additional information about the piece of mail, such as its origin, postmark, routing information, etc.

Various devices for encoding data currently exist and are under development. These devices generally permit objects to be tagged or labeled to permit machines to read data associated with the object. Radio-frequency identifier (RFID) tags deliver information by radio signals to a reader just as a transponder does. One of the attractions of RFID devices is their potential to carry a large quantity of information. This is in contrast to conventional bar codes whose data capacity is much more limited. Another alternative to conventional bar-codes are two-dimensional bar codes. These are two-dimensional symbols that are capable of encoding much more data than a conventional bar-code. Another encoding device is the iButton®, a small token that stores information that can be read by a reader that makes electrical contact with the iButton®. Still other devices for storing information include printed and non-printed (e.g., etched) machine readable symbols (e.g., using a pattern recognition process) and digital watermarks.

RFID tags may be programmable and may also include sensors that can record, right in the tag, various environmental factors.

Unlike bar-codes, that are currently in use to identify mails, which can encode only enough data to correlate a small amount of information, some machine-readable label (MRL) devices can store enough information to accomplish some very interesting things. For example, if attached to a product, it can uniquely identify that particular product, which could be tied in a central database to its date of manufacture, the shipment vessel it was conveyed in, its date of shipment, the retailer to whom it was shipped, to whom it was sold, how it was manufactured, when, etc. Another advantage is that some are capable of being scanned by holding a reader some distance away and without precisely aiming the reader with respect to the MRL device. Some readers are capable or reading many MRL devices at once, for example RIFD readers.

There is a need in the current state of the art for a remotely accessible receptacle for mails delivered in a conventional postal system.

### SUMMARY OF THE INVENTION

According to the invention, in one aspect, a system for remotely determining the contents of a mail receptacle includes a machine-readable label incorporated into a piece of mail programmed with at least one property of a piece of mail. The system also includes a machine-readable label reader for reading the machine-readable label, a processor for receiving the at least one property of the piece of mail from the machine-readable label reader, and a memory for storing the at least one property of the piece of mail. In addition, the system also includes a means for remotely accessing the memory to determine the contents of the mail receptacle.

In several embodiments of the invention, the machine-readable label can include a radio transponder or transmitter. Further, the means for remotely accessing can be a telephony means, an internet means, a wireless means, or an email means.

In several other embodiments of the invention, the processor is programmable to initiate the means for remotely accessing the memory to contact a user. The processor can be programmed to initiate the means for remotely accessing the memory when the processor detects a piece of mail containing at least one property programmed by the user.

In one aspect of the invention, a method for notification of the contents of a mail receptacle includes several steps. One step is incorporating a machine-readable label into a piece of mail, the machine-readable label containing information about at least one property of the piece of mail. Additional steps include receiving the information from the machine-readable label, storing the information from the machine-readable label, and communicating the information from the machine-readable label to a user.

In one embodiment of the invention, the method also includes the steps of programming a processor to initiate the communicating step when at least one property of a piece of mail is detected, and detecting the at least one property of a piece of mail. In another embodiment of the invention the communicating step includes notifying the user that a piece of mail is within the mail receptacle when the at least one property of a piece of mail is detected in the detecting step.

In an additional aspect of the invention, a method for remotely determining the contents of a mail receptacle includes several steps. One step is incorporating a machine-readable label into a piece of mail, the machine-readable label containing information about at least one property of the piece of mail. Additional steps include receiving the information from the machine-readable label, storing the information from the machine readable label, and remotely accessing stored information to determine the contents of the mail receptacle.

In one embodiment of the invention, the remotely accessing step includes remotely accessing the stored information by telephony means, an internet means, a wireless means, or an email means.

In one aspect of the invention, a method of doing business includes several steps. One step is incorporating a machine-readable label to a piece of mail, the machine-readable label containing information about at least one property of the piece of mail. Additional steps are receiving the information from the machine-readable label, storing the information from the machine-readable label, remotely accessing the stored information to determine the contents of the mail receptacle, and affecting the sale of goods or services based on the stored information.

The invention provides many advantages, some of which are elucidated with reference to the embodiments below.

### BRIEF DESCRIPTION OF THE DRAWINGS

FIG. 1 is a depiction of a remotely accessible mail receptacle;

FIG. 2 is a diagram of a system for remotely determining the contents of a mail receptacle;

FIG. 3 is a flow chart of a procedure for remotely determining the contents of a mail receptacle;

FIG. 4 is a flow chart of an alternate procedure for remotely determining the contents of a mail receptacle;

FIG. 5 is a flow chart of a method of doing business including a procedure for remotely determining the contents of a mail receptacle.

### DETAILED DESCRIPTION OF THE PRIMARY EMBODIMENT

The proposed system and method provide for the ability to remotely access a mail receptacle to verify its contents.

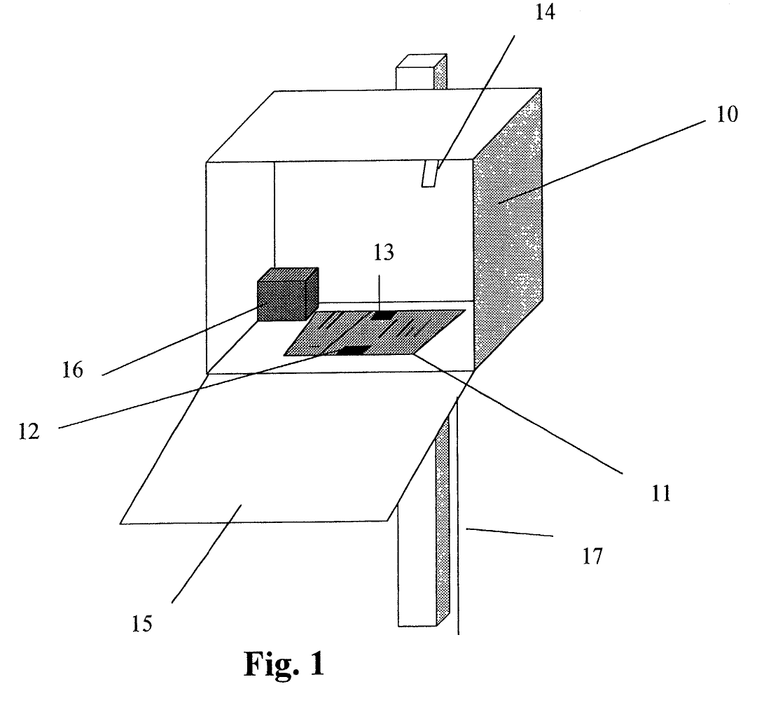

FIG. 1 illustrates a preferred embodiment of the proposed mail receptacle. In this embodiment, mail receptacle 10 is a conventional mailbox, usually found near a residential home. However, mail receptacle 10 may also be a mail slot, package room, post office box, or any other known means for receiving mail. Conventional postal systems (i.e., via a postal carrier) deposit mails, such as letter 11, in mail receptacle 10. Postage 12, such as a stamp is affixed to letter 11. Additionally, letter 11 includes an affixed or inserted machine-readable label 13.

The sender of letter 11 programs machine-readable label 13 with information regarding the contents of the letter. For example, if the letter contains urgent information such as test results or a job offer, the sender may program machine-readable label 13 with relevant information. A sender can program very specific information about the contents of letter 11, for example, the fact that it contains a refund check, or the sender can program very general information, such as the size and weight of letter 11. In addition, the sender can encrypt the information he programs on machine-readable label 13. The recipient's machine-readable label reader can then decrypt the information based on an address algorithm. This will prevent improper persons from accessing any sensitive information the sender may wish to program.

Once mail receptacle 10 receives letter 11, sensor 14 is triggered. In this embodiment, closing the door 15 to mail receptacle 10 triggers sensor 14. Sensing can occur through any known sensing device or technique. Upon sensing that mail has been deposited in mail receptacle 10, block 16 reads the information stored on machine-readable label 13, processes the information, and stores the information. A user can remotely access block 16 via transmission line 17 by telephoning his mail receptacle, or the information stored on machine-readable label 13 can be connected with the user's voice mail system. This enables the user to simply check his mail receptacle and his voice mail at the same time. Alternatively, transmission line 17 can be an internet transmission line and a user can then remotely access block 16 via the internet and check his mail receptacle 10 similar to how he would check his email. Further, transmission line 17 can be a wireless transmission means.

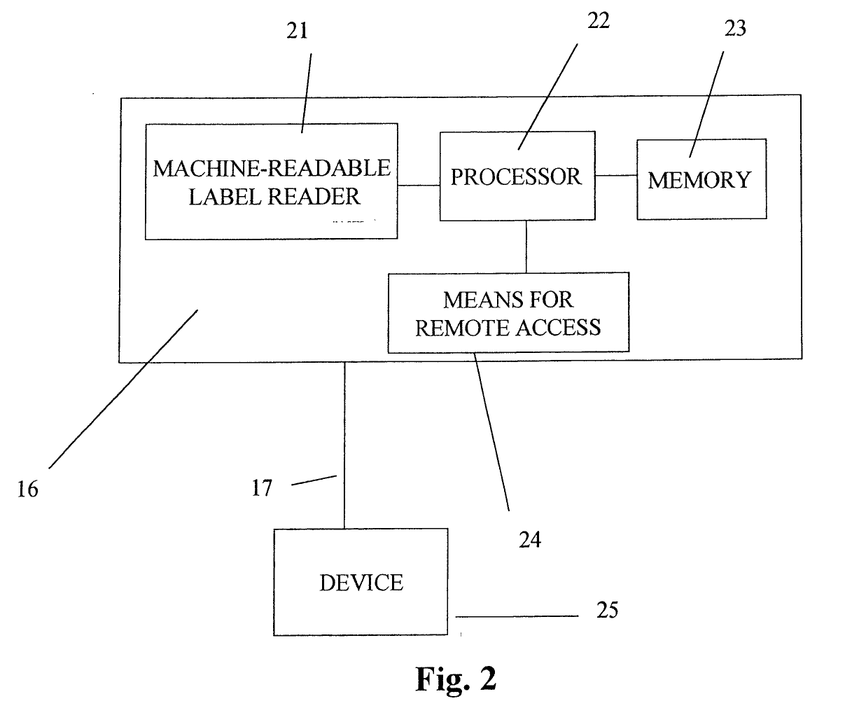

FIG. 2 depicts a system for remotely determining the contents of a mail receptacle. Block 16 contains machine-readable label reader 21, processor 22, memory 23 and a means for means for remotely accessing the memory 24. When door 15 triggers sensor 14, machine-readable label reader 21 activates and reads the information stored on machine-readable label 13. Stamp 12 may also contain a machine-readable label with information which machine-readable label reader 21 can also read. Processor 22 processes the information from machine-readable label 13 and stores it in memory 23.

A user can remotely interact with means for remotely accessing the memory 24 by transmission line 17 and device 25. Remotely accessing the memory 23 can occur in several manners. For example, device 25 can be a telephone means for accessing the memory 24 and the user will hear all the information stored in memory 23 (i.e., read from machine-readable label 11 by machine-readable label reader 21). The user can then sort through the information in a similar manner to a current voice mail system using key functions or voice controls to navigate through the information. Alternatively, device 25 is a means for accessing the internet by which a user can access the information using a method similar to email.

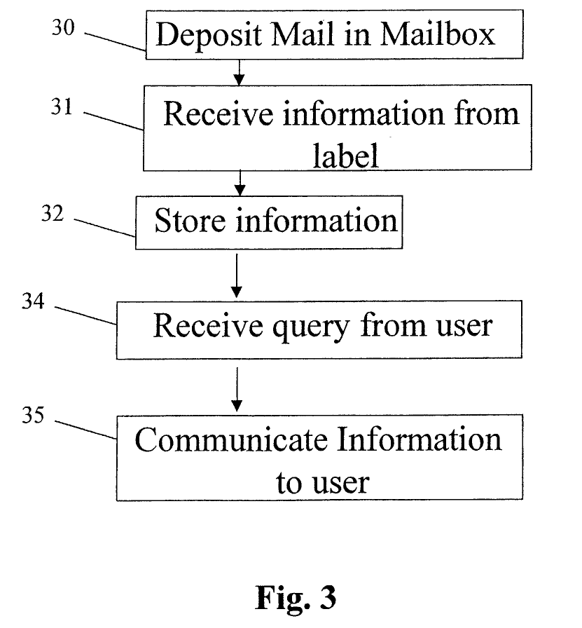

FIG. 3 is a flow chart of a procedure for remotely accessing the stored information to determine the contents of the mail receptacle. In this embodiment, in step 30 a postal carrier deposits mail in the user's mail receptacle. Machine-readable label reader 21 reads the information stored on any machine-readable labels on or inside the mail. Processor 22 filters the information and stores any previously non-stored information in memory 23 in step 32. The user remotely performs a query in step 34 by, for example, calling a specific telephone number and accessing means for remotely accessing the memory 24 by a system analogous to a prior art voice mail system. Alternatively, as a further example, a user can access the information over the internet, or via a wireless device such as a pager or PDA. Means for remotely accessing the memory 24 communicates the information stored on memory 23 to the user according to the type of device with which a user performs a query.

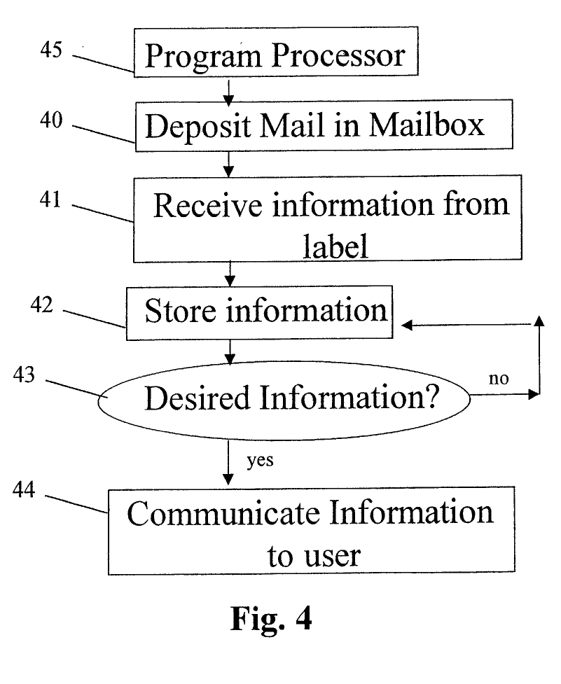

FIG. 4 is a flow chart of a procedure for communicating information from a machine-readable label to a user. In this embodiment, a user can program processor 22 to notify him once it detects specific information. In one example, a user desires to know when a certain magazine arrives in his mail receptacle. The user programs processor 22 to activate means for remotely accessing the memory 24 when processor 22 detects information indicating that the magazine has arrived in step 45. In step 40, a postal carrier deposits mail in the user's mail receptacle. Machine-readable label reader 21 reads the information stored on any machine-readable labels on the deposited mail in step 41. Processor 22 directs memory 23 to store the information in step 42 and verifies whether the information indicates that the magazine has arrived in step 43. Memory 23 additionally stores the information in step 42. If the information is not the programmed desired information, then processor 22 returns to step 42. If processor 22 determines that the information does indicate that the magazine has arrived, it activates means for remotely accessing the memory 24 in step 44. As an example, means for remotely accessing the memory can send the user an email that the magazine has arrived. Alternatively, as another example, the means for remotely accessing the memory can be programmed to telephone the user and convey that the information indicates that the magazine has arrived.

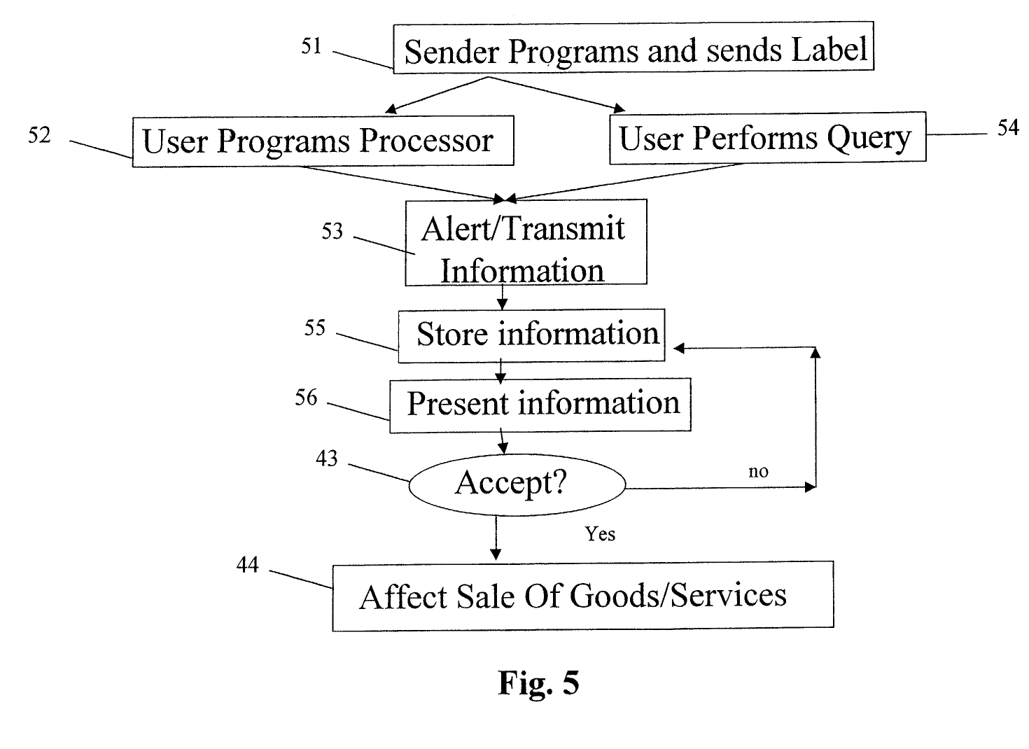

FIG. 5 is a flow chart of a method of doing business including a procedure for remotely determining the contents of a mail receptacle. In this embodiment, a user can either program processor 22 to notify him when it detects specific information in a machine-readable label, or he can remotely perform a query to check the contents of his mail receptacle. In one example, the sender programs machine-readable label 11 with information that will affect the sale of goods or services and sends it to a user in step 51. For example, the sender, a retailer, sends the user an advertisement. Incorporated in the advertisement is machine-readable label 11. The sender programs machine-readable label 11 with information relating to a discount on a product, for example, a certain shirt. The information can include product information, a coupon, or any other information that relates to the product or may affect the sale of that product or service.

If a user desires to know when the advertisement arrives in his mail receptacle, he can program processor 22 to activate means for remotely accessing the memory 24 when processor 22 detects information indicating that the advertisement has arrived in step 52. In step 53 means for remotely accessing the memory 24 alerts user that the advertisement arrived and can also provide the user with the information from the advertisement. Alternatively the user can perform remote queries in step 54 to obtain the information from the advertisement.

Once the user receives the advertisement information, he stores it onto a local memory, such as a PDA, or a cellular telephone in step 55. Alternatively the user can simply receive the information in the form of an alpha-numeric code which, when presented to the retailer in step 56, will be accepted to affect the sale of the certain shirt.

The user then presents the retailer with the information in step 56. This can occur by any known means of transmitting information, for example, through infrared signal transmission, by reciting an alpha-numeric code, or by presenting the retailer with a machine-readable label. In step 57, the retailer accepts the information and, in step 58, uses the information to affect the sale of the shirt. In this manner a user can, for example, remotely check his mail receptacle while physically in a retail or service establishment in order to take advantage of an discounts or offers the retailer or service provider has sent him via a conventional mail system.

The preceding expressions and examples are exemplary and are not intended to limit the scope of the claims that follow.

What is claimed is:

1. A system for remotely determining the contents of a mail receptacle comprising:
a machine-readable label programmed with at least one property of a piece of mail, said machine-readable label being incorporated into the piece of mail;
a machine-readable label reader for reading the machine-readable label;
a processor for receiving the at least one property of the piece of mail from the machine-readable label reader;
a memory for storing the at least one property of the piece of mail; and
a means for remotely accessing the memory to determine the contents of the mail receptacle.

2. The system of claim 1, wherein said machine-readable label includes a radio transponder or transmitter.

3. The system of claim 1, wherein the means for remotely accessing further comprises a telephony means, an internet means, a wireless means, or an email means.

4. The system of claim 1, wherein the processor is programmable.

5. The system of claim 4, wherein the processor is programmable to initiate the means for remotely accessing the memory to contact a user.

6. The system of claim 5, wherein the processor initiates the means for remotely accessing the memory when the processor detects a piece of mail containing at least one property programmed by the user.

7. A method for notification of the contents of a mail receptacle comprising:
incorporating a machine-readable label into a piece of mail, said machine-readable label containing information about at least one property of the piece of mail;
receiving the information from the machine-readable label;
storing the information from the machine-readable label; and
communicating the information from the machine-readable label to a user.

8. The method of claim 7, further comprising the steps of programming a processor to initiate the communicating step when at least one property of a piece of mail is detected, and detecting the at least one property of a piece of mail.

9. The method of claim 8, wherein the communicating step further comprises notifying the user that a piece of mail is within the mail receptacle when the at least one property of a piece of mail is detected in the detecting step.

10. A method for remotely determining the contents of a mail receptacle comprising:
incorporating a machine-readable label to a piece of mail, said machine-readable label containing information about at least one property of the piece of mail;
receiving the information from the machine-readable label;
storing the information from the machine-readable label; and
remotely accessing the information to determine the contents of the mail receptacle.

11. The method of claim 10, wherein the remotely accessing step further comprises remotely accessing the stored information by telephony means, an internet means, a wireless means, or an email means.

12. A method of doing business comprising:
incorporating a machine-readable label to a piece of mail, said machine-readable label containing information about at least one property of the piece of mail;
receiving the information from the machine-readable label;
storing the information from the machine-readable label;
remotely accessing the information to determine the contents of the mail receptacle; and
affecting the sale of goods or services based on the information.
